(19) United States
(12) Patent Application Publication
(10) Pub. No.: US 2026/0133309 A1
(43) Pub. Date: May 14, 2026

(54) LOCALIZED TRIGGERING OF HUMAN ACTIVITY ANALYSIS

(71) Applicant: Orange, Issy-Les-Moulineaux (FR)

(72) Inventors: Julien CUMIN, Chatillon Cedex (FR); Kévin L’HEREEC, Chatillon Cedex (FR)

(21) Appl. No.: 19/118,743

(22) PCT Filed: Sep. 15, 2023
(86) PCT No.: PCT/EP2023/075529

§ 371 Date: Apr. 4, 2025

(30) Foreign Application Priority Data
Oct. 6, 2022 (FR) FR2210232

(51) Int. Cl. G01S 13/56; G01S 13/08

(52) U.S. Cl. CPC G01S 13/56; G01S 13/08

(57) ABSTRACT

A method of determining human activity in an environment in which at least one sensor is configured to measure a parameter relating to human activity. The method includes: receiving an indication of a human presence, and activating the sensor when a human presence is being detected in the environment.

### CROSS-REFERENCE TO RELATED APPLICATIONS

This application is filed under 35 U.S.C. § 371 as the U.S. National Phase of Application No. PCT/EP2023/075529 entitled “Localized Triggering of Human Activity Analysis” and filed Sep. 15, 2023, and which claims priority to FR 2210232 filed Oct. 6, 2022, each of which is incorporated by reference in its entirety.

### BACKGROUND

### Field

This disclosure concerns the field of sensors, in particular sensors for measuring human activities.

### Description of the Related Technology

The identification and analysis of human activities in connected environments uses information about the ambient context of the environment, and can therefore make use of various sensors, such as:
those capturing environmental information (temperature, brightness, CO2 emissions, etc.),
those capturing the opening of doors, windows, cupboards or others,
those capturing movement (for example infrared sensors),
more generally, those capturing images, such as cameras,
more generally, those capturing sounds, such as microphones, etc.

Very often, sensors of different types may be installed conjointly in order to increase the relevance of the information captured in an environment, and in particular the accuracy of a possible identification of human activities.

These data sources are most often confined to a location: they can only record events occurring in their “field of view”. Thus, to be able to identify human activities in a large environment, potentially consisting of several rooms of a home for example, it is generally necessary to multiply the data sources in order to cover the environment as much as possible.

To be able to identify human activities in the environment, it is necessary to continuously analyze the data sent by the sensors, via specific algorithms. In particular, the sensors must send data at each change measured in the environment and which could be linked to a change in activity.

These constraints-measurements, analysis, and multiplicity of sensors imply a significant consumption of electricity, of the radiofrequency spectrum, and of computational resources. Often, the sensors of these systems are battery operated, and methods are sought for reducing their consumption.

### SUMMARY

The present description improves the situation.

To this end, it proposes a method for activating a determination of human activity in an environment in which at least one sensor is configured to measure at least one parameter relating to a human activity, the method comprising:
making use of a human presence detection device to detect a human presence in the environment, and
activating the sensor if a human presence has been detected in the environment.

Such an embodiment thus makes it possible to reduce the energy supplied to the sensor, as well as the energy for processing the data obtained from the sensor, if no human presence has been detected for at least a certain period of time.

Here, the term “environment” means a spatial environment, such as a building (a home, an office building, or the like), or an augmented reality room, or some other environment.

A human activity that may be determined is for example the current occupation of a person in the environment (focused on a work task, watching entertainment on a screen, or some other occupation). For example, a sensor may measure a user's eye movements, and this measurement data is sent to a human activity recognition device capable of interpreting the eye movements as characteristic of viewing entertainment or, on the contrary, reading a work document for example.

Thus, the implementation of the above method not only provides savings in the energy supplied to the sensor, but also in the computing resources necessary for the operation of this human activity recognition device, when no human presence is detected in the environment.

Thus, in one embodiment, the sensor (at least) may be deactivated in the event of non-detection of a human presence after a preset time delay.

It is thus possible to stop supplying power to the sensor(s) if no human presence has been detected for a certain selected amount of time (a few minutes for example).

In one embodiment, the human presence detection device may be configured to determine the location of the detected human presence, in the environment.

Such an embodiment makes it possible to activate, for example, one or more sensors within a particular zone of the environment where a human presence has been detected and located, while one or more sensors in other zones of the environment can remain inactive.

Thus, in an embodiment where the environment comprises a plurality of monitoring zones, with at least one sensor assigned to each zone and configured to measure at least one parameter relating to human activity in its zone, the method may comprise:
making use of the human presence detection device in each zone of the environment, and
selectively activating at least one sensor assigned to a zone, if a human presence has been detected in that zone.

This thus saves power and reduces the data processing for data coming from the other sensors in the environment, if no human presence is detected in the other areas of the environment.

In an embodiment where a set of a plurality of sensors is assigned to at least one zone of the environment, the method may comprise activating the sensors of said set in the event that a human presence is detected in said at least one zone, in order to measure human activity in said at least one zone.

Thus, in this embodiment, activating the sensors of the zone in which a human presence has been detected concerns all sensors assigned to this zone, typically in order to obtain a relevant analysis of the human activity in that zone.

For example, all of the data these sensors send may be used for accurately determining a human activity in progress in that zone.

In such an embodiment, the method may then comprise transmitting the data measured by said at least one sensor, to a human activity recognition device.

For example, the human activity recognition device may be configured to operate by machine learning based on the locations where a human presence is detected (“place-based machine learning”).

In one embodiment, the human presence detection device may be configured to transmit/receive radiofrequency radiation within the environment.

For example, in such an embodiment, a disruption of this radiofrequency radiation may be determined, deducing from this that a human presence is at least partially obstructing the radiation.

Thus, in such an embodiment, the human presence detection device may be configured to measure an attenuation of a radiofrequency signal between at least one transmitter and at least one receiver, and to deduce, from the measured attenuation, a temporary presence of an obstacle between the transmitter and the receiver, the temporary presence being recognized as a human presence in the environment.

For example, in such an embodiment, the human presence detection device may be configured to transmit/receive radiofrequency radiation of the Wifi type.

Such a technique, referred to as “Wifi Sensing”, is an optimal choice for activating the relevant sensors for measuring at least one parameter relating to human activity, without needing to rely on conventional presence sensors which are expensive. Wifi Sensing can be implemented with pre-existing equipment such as a gateway and fixed objects connected to the gateway via a Wifi link, and therefore without the need for other sensors. It offers the possibility of detecting a human presence and determining the location of this presence with an accuracy that is sufficient for the requirements of monitoring human activity.

Alternatives to such an embodiment are possible. For example, according to another embodiment, the human presence detection device may comprise one or more motion sensors, or the two embodiments may be combined. Thus, for example, three embodiments for the human presence detection device are conceivable:
a WiFi Sensing type of detection, or
a detection using motion sensors that detect a human presence, or
a combination of these two embodiments.

In an embodiment in which said at least one transmitter and at least one receiver comprise a gateway of a local area network and a plurality of objects connected to the gateway, this plurality of connected objects may be selected for determining the location of a detected human presence by measuring the attenuation of the radiofrequency signal between the gateway and each connected object.

For example, a trilateration involving the gateway and several connected objects of the environment may enable determining the location, within a given zone, of the human presence that has been detected. In this case, the sensor(s) assigned to this zone may be activated.

In such an embodiment, each connected object and the gateway may be assigned fixed positions in the environment.

Thus, the connected objects selected to perform the detection and the location determination may be assigned to fixed, chosen positions, as is typically the case for a connected television set, or a connected printer, or connected lamps for example.

The present description also relates to an activation device for activating a determination of human activity in an environment in which at least one sensor is configured to measure at least one parameter relating to a human activity, the activation device being:
connected to the sensor and to a human presence detection device, and
configured to implement the method presented above.

Thus, typically, such an activation device may be configured to activate the sensor if a human presence has been detected in the environment by the human presence detection device.

The present description also relates to a human presence detection device for detecting a human presence in an environment in which at least one sensor is configured to measure at least one parameter relating to a human activity, for the implementation of the above method.

The human presence detection device and the activation device described above may be parts of a single device or may be separate devices.

Such a human presence detection device may be, for example, a gateway of a radiofrequency-based local area network (for example a Wifi network), or possibly another terminal of a local area network (via a radiofrequency link other than Wifi for example, such as Bluetooth®), such as, for example, a smartphone type of mobile terminal of a user, running a computer application to implement the above method.

The present description also relates to a system comprising at least:
a sensor configured to measure at least one parameter relating to a human activity,
a human presence detection device for detecting a human presence in an environment in which the sensor is located, and
an activation device, connected to the sensor and to the human presence detection device, and configured to implement the method presented above.

This activation device may be integrated into the human presence detection device (for example in the form of a module programmed in a gateway, capable of detecting and determining the location of a human presence), or may be separate (for example integrated into a server, a gateway, or a terminal of the local area network, or the like).

The system may further comprise a human activity recognition device, connected to the activation device in order to perform human activity recognition when the sensor(s) are activated.

This human activity recognition device may be integrated into the aforementioned system (for a human activity analysis solution that is local) or may be separate (for a remote analysis based on data sent by the sensor(s)).

According to another aspect, a computer program is proposed comprising instructions for implementing all or part of a method as defined herein when the program is executed by a processing circuit (for example the processing circuit of the aforementioned activation device). According to another aspect, a non-transitory storage medium readable by a processing circuit is proposed, in which such a program is stored.

### BRIEF DESCRIPTION OF THE DRAWINGS

Other features, details and advantages will become apparent upon reading the detailed description below, and upon analyzing the attached drawings, in which:

FIG. 1 shows an example of a system for implementing the above method, according to one embodiment.

FIG. 2 shows an example of the steps of a method as defined above, according to one embodiment.

FIG. 3 illustrates a definition of the zones RO1, RO2 of a given environment ENV, and the sensors which are assigned to each of these zones, according to one exemplary embodiment.

FIG. 4 shows elements of a human presence detection and location-determination device, these possibly being elements such as a router (for example a gateway GW of a local area network) connected to terminals (for example connected objects such as a connected television set TV or a connected printer PRN), according to one exemplary embodiment.

FIG. 5 illustrates an awakening of sensors (in white) for a given zone in which a human presence has been detected, while the sensors of the other zones of the environment remain deactivated (in black).

FIG. 6 shows an example of a processing circuit of an activation device of a system of the type defined above, according to one embodiment.

### DETAILED DESCRIPTION OF CERTAIN ILLUSTRATIVE EMBODIMENTS

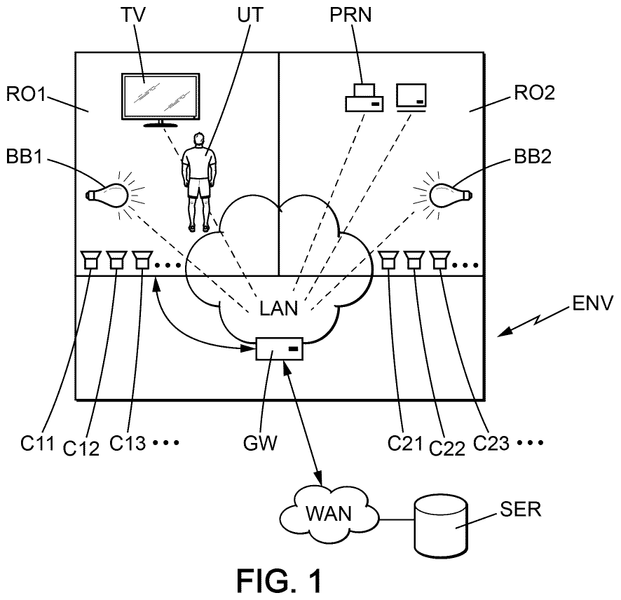

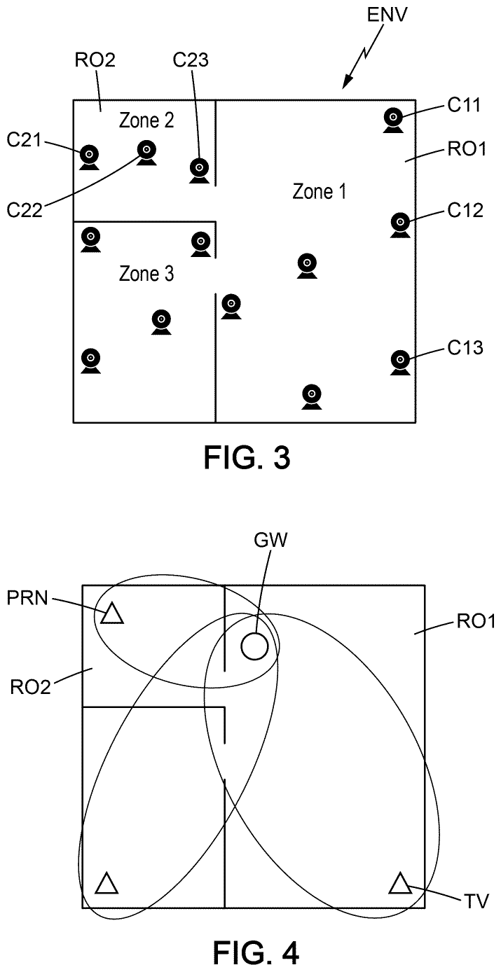

FIG. 1 shows a human presence detection device based on radiofrequency radiation, in the form of a gateway GW of a local area network LAN in this exemplary embodiment, to which are linked connected objects such as one or more connected lamps BB1, BB2, etc., for example arranged in respective rooms RO1, RO2, etc. of an environment ENV, as well as a connected television set TV in one room, and a connected printer PRN in another room. As presented further below with reference to FIGS. 3 to 6, radiofrequency radiation between gateway GW and each connected object (TV, BB1 in the example illustrated in FIG. 1) may be disrupted by the body of a user UT when he or she is in proximity to these connected objects, absorbing part of the radiation that links gateway GW to connected objects TV, BB1. The disruption of each of these radiations can be measured in order to detect a human presence UT in this room, and these disruptions may be compared to each other in order to determine the location of this presence. In this case, in the example illustrated in FIG. 1, the radiofrequency radiation is more disrupted for the connected objects in room RO1 (which are television set TV and lamp BB1) than for those in room RO2: from this it can typically be deduced that the human presence UT was detected in room RO1, and not in room RO2.

In this case, only sensors C11, C12, C13, etc. of room RO1 may be activated, while sensors C21, C22, C23, etc. of room RO2 may be deactivated (or remain deactivated if they already are).

A radiofrequency range suitable for such detection is the Wifi range (a few tens of meters) and this technique of detection through disruption of the Wifi radiation is then called “Wifi Sensing”.

The techniques referred to as “Wifi Sensing” aim to detect a human presence, or even gestures, by analyzing disruptions caused by the human body in the propagation of Wifi waves, typically between a router and a terminal (typically between a gateway of a local area network and a connected object in the local area network). The terminal may be any type of connected object and is preferably fixed for example in a predefined area. In practice, it may be a connected television or printer, or connected light bulbs for example, usually in fixed positions.

The main advantage of Wifi Sensing is to take advantage of the transmission of Wifi waves which penetrate all materials of connected environments (therefore without high additional installation or energy consumption costs). This technique also allows detection within a wide field of view (able to pass through walls and other obstacles within a reasonable radiofrequency range of a few tens of meters). It thus makes it possible to detect the presence of people in an environment such as a home or a workplace and in particular to observe movements of these people in such an environment, for example.

Furthermore, it is possible to roughly determine the position of the human presence, in particular when several connected objects are arranged in the environment.

On the other hand, this technology is far from being sufficiently detailed to be able to be used to identify a specific human activity. The simple detection of a presence, or the identification of a posture or movement of a person, are not sufficiently informative to identify the person's complex activities, which are more dependent on a more general context.

A solution is therefore proposed here which aims to make use of the information coming from Wifi Sensing to activate one or more sensors in the environment in an optimal manner, in order to improve the detection of human activities in progress, and to do so while managing a reasonable consumption of energy by these sensors, as well as of computational resources by the processes which analyze human activities in the observed environment.

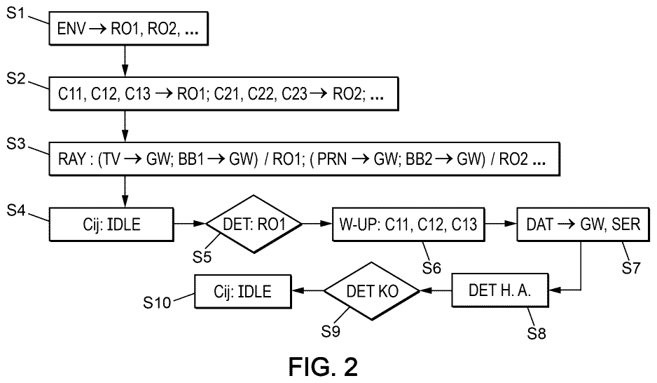

The proposed solution implements a method for locally triggering the analysis of a human activity based on one or more locally activated sensors, following the detection of a human presence, for example by Wifi Sensing. Reference is made to FIG. 2 which illustrates steps of such a method as an example.

In a first step S1 of the method, the environment is broken down into a list of distinct zones (typically rooms separated by walls). In the next step S2, the sensors of the environment are associated with each zone, according to their position and field of detection (typically, a sensor installed in a room is associated with that room for example). This breakdown is set up by a user such as an installer, or by any other method of automatically breaking down an environment into zones.

This situation is illustrated in FIG. 3, showing a definition of zones of a given environment (here, rooms delimited by partitions such as walls).

In another step S3 of the method, a human presence detection device, of the Wifi Sensing type, which typically may be composed of a router such as a gateway GW (circle in FIG. 4) and terminals which may be connected objects (triangles in FIG. 4), is configured so that it can adequately cover each zone RO1, RO2, etc. in terms of human presence detection. The detection coverage between the router and a terminal is generally an ellipse whose foci are the router and the terminal.

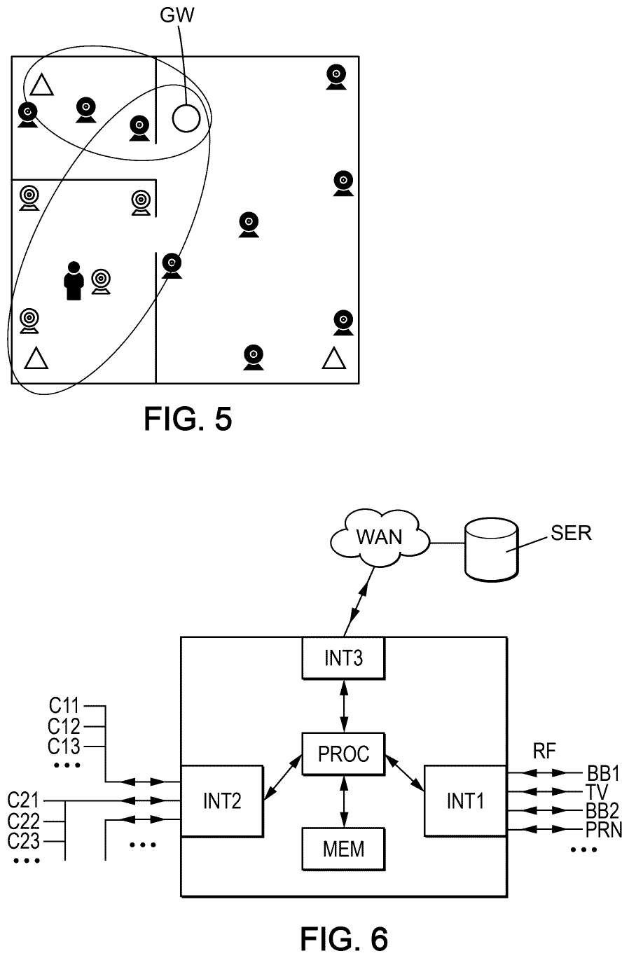

The following steps of the method may then be as follows:
In the nominal state, the environmental sensors are “idle” in step S4 and are configured so they do not measure or transmit any information if no human presence is detected;
Detection of a human presence in step S5 in one of the zones of the environment, via Wifi Sensing, triggers the awakening of sensors C11, C12, C13 assigned to zone RO1. In step S6, all sensors in the zone concerned RO1 are then “awakened” (in white in FIG. 5): a wakeup command is sent to each of them via the communication network to which they are connected (for example the local area network LAN), this network being used, among other things, for sending measurements. The sensors associated with the other zones remain idle (in black in FIG. 5);
The awakened sensors send their measurements in step S7 according to their nominal operating mode and their capabilities. This information is sent over the communication network to which they are connected, for example via gateway GW and to a server SER that processes the data sent by the sensors and is connected to gateway GW by a wide area network WAN. Thus, an activation device, for example in the form of a processing circuit connected to the sensors, and which may comprise for example gateway GW, sends the measurements obtained from the sensors to a human activity recognition device, such as server SER, as soon as a presence has been detected in a zone. All of the sensors associated with this zone are awakened. The activity recognition device SER then has access to the data sent by the sensors in the zone and can use them to identify, in step S8, a particular human activity in the awakened zone, for example in order to transmit its inferences to other systems which make use of them;
When a human presence is no longer detected in the zone in step S9, after a time delay of a few minutes for example, an “idle” order is sent to each of the sensors of the zone in step S10.

In one embodiment, gateway GW comprises the detection device as well as the activation device which were mentioned above. Thus, gateway GW is configured to detect a human presence and to activate the sensors of the zone when a human presence is detected.

An example of human activity recognition implemented in step S8 may be, without being limited thereto, an approach using place-based machine learning, as described in the following article:

“Human activity recognition using place-based decision fusion in smart homes. In International and interdisciplinary conference on modeling and using context”, J.
Cumin, G. Lefebvre, F. Ramparany, J. L. Crowley.

The above method works in the same manner if several presences are detected in different zones simultaneously: the sensors of each zone concerned are awakened and the information is transmitted, as well as the data measured by the respective sensors, to the human activity recognition device.

This method using sensor awakening may be instantiated:
locally on one of the devices of the local area network of the environment, such as gateway GW, or on another device of the local area network such as a connected computer or a user terminal connected to the network for example,
or on a remote machine such as server SER communicating with the sensors of the local area network of the environment, for example via gateway GW, as illustrated in the example of FIG. 1.

Thus, in one embodiment, the human activity recognition may be executed locally on one or more devices of the network, and in another embodiment, the activity recognition is executed on a remote machine SER in the “cloud”.

In either of these embodiments, the activation or deactivation of the sensors may be carried out locally (at a unit connected to the local area network) or remotely (at a unit connected to server SER for example). FIG. 6 illustrates, as an example, the first embodiment in which an activation device, here in the form of a processing circuit (for example integrated into gateway GW), may comprise:
a first interface INT1, for communication by radiofrequency RF (for example Wifi connection) with different connected objects in the environment,
a second interface INT2, for controlling sensors C11, C12, C13, etc., C21, C22, C23, etc., arranged in the environment, on the one hand in order to activate or deactivate at least one set of appropriate sensors C11, C12, C13 in the event that a human presence or absence is detected in zone RO1 to which this set of sensors is assigned, and on the other hand to receive the data originating from these sensors and to transmit the data for example to a remote processing server SER via a wide area network WAN to which a third communication interface INT3 is connected,
a processor PROC capable of controlling communication interfaces INT1, INT2, INT3, and
a memory MEM storing at least the instructions of a computer program, and accessible by processor PROC in order to implement the above method when processor PROC of the processing circuit executes the instructions of the program.

The object of the present description may find applications in the recognition of human activities in connected environments having radiofrequency-based detection means (for example Wifi), for example in “smart home” systems (Connected Home, Protected Home, etc.), or in intelligent buildings for the service sector (such as connected workplaces or nursing homes or hospitals), or in augmented reality spaces.

1. A method for activating a determination of human activity in an environment in which at least one sensor is configured to measure at least one parameter relating to a human activity, the method comprising:
receiving an indication of a human presence environment, and
activating the sensor if when a human presence is being detected in the environment.

2. The method according to claim 1, wherein the sensor is deactivated in the event of non-detection of a human presence after a preset time delay

3. The method according to claim 1, wherein the human presence detection device is configured to determine the location of the detected human presence, in the environment.

4. The method according to claim 3, wherein the environment comprises a plurality of monitoring zones with at least one sensor (BB1, assigned to each zone and configured to measure at least one parameter relating to human activity in its zone, the method comprising:
making use of the human presence detection device in each zone of the environment, and
selectively activating at least one sensor assigned to a zone, if a human presence has been detected in that zone.

5. Method The method according to claim 4, wherein a set of a plurality of sensors assigned to at least one zone of the environment, the method comprising an activation of the sensors of the set in the event that a human presence is detected in the at least one zone, in order to measure human activity in the at least one zone.

6. The method according to claim 1, comprising a transmission of the data measured by the at least one sensor, to a human activity recognition device.

7. The method according to claim 1, wherein the human presence detection device is configured to transmit/receive radiofrequency radiation within the environment.

8. The method according to claim 7, wherein the human presence detection device is configured to measure an attenuation of a radiofrequency signal between at least one transmitter and at least one receiver, and to deduce, from the measured attenuation, a temporary presence of an obstacle between the transmitter and the receiver the temporary presence being recognized as a human presence in the environment

9. The method according to claim wherein the human presence detection device is configured to transmit/receive radiofrequency radiation of the Wifi type.

10. The method according to one of claim 8, wherein, the at least one transmitter and at least one receiver comprising a gateway of a local area network and a plurality of objects connected to the gateway, the plurality of connected objects is selected for determining the location of a detected human presence by measuring the attenuation of the radiofrequency signal between the gateway and each connected object.

11. The method according to claim 10, wherein each connected object and the gateway are assigned fixed positions in the environment.

12. An activation device for activating a determination of human activity in an environment in which at least one sensor is configured to measure at least one parameter relating to a human activity, the activation device being connected
to the sensor and to the human presence detection device, and being configured to implement the method according to claim 1.

13. A human presence detection device for detecting a human presence in an environment in which at least one sensor is configured to measure at least one parameter relating to a human activity, for the implementation of the method according to of claim 1.

14. A system comprising at least:
a sensor configured to measure at least one parameter relating to a human activity,
a human presence detection device for detecting a human presence in an environment in which the sensor is located, and
an activation device according to claim 12.

15. A non-transitory computer storage medium storing instructions of a computer program, the instructions causing the implementation of the method according to one of claim 1, when said the computer program is executed by a processor.
